(19) United States
(12) Patent Application Publication
(10) Pub. No.: US 2010/0276563 A1
(43) Pub. Date: Nov. 4, 2010

(54) MEMBER FORMING A SUPPORT FOR A DEVICE AND TYRE COMPRISING SUCH A MEMBER

(75) Inventors: Bernard Cubizolle, Cebazat (FR); Claudio Battocchio, Riom (FR)

Correspondence Address: FITZPATRICK CELLA HARPER & SCINTO, 1290 Avenue of the Americas, NEW YORK, NY, 10104-3800, US

(73) Assignees: SOCIETE DE TECHNOLGIE MICHELIN, Clermont Ferrand (FR); MICHELIN RECHERCHE ET TECHNIQUE S.A., Granges-Paccot (CH)

(21) Appl. No.: 12/738,506

(22) PCT Filed: Oct. 23, 2008
(86) PCT No.: PCT/FR08/51915

§ 371 Date: Jun. 29, 2010

(30) Foreign Application Priority Data
Oct. 23, 2007 (FR) 0758522

(51) Int. Cl. F16M 13/02

(52) U.S. Cl. 248/633

(57) ABSTRACT

A member forming a support for a device includes a connecting portion for connecting with a tyre and a supporting portion for supporting the device. The connecting portion includes a connecting surface for connecting with the tyre, an upper surface, and a peripheral edge. The peripheral edge is delimited by a joining surface between the mutually opposite upper and connecting surfaces, which converge on the joining surface at an angle (α) of between 9 and 15 degrees.

The present invention relates to the technical field of tyres for motor vehicles.

More precisely, the invention relates to the attachment of a device, notably an electronic device, such as a pressure sensor, to a tyre. The electronic device is rigid and it is unadvisable to attach it directly to the tyre because that risks disrupting the mechanical behaviour of the tyre when running, notably when it deforms.

It is therefore known practice in the prior art, notably according to document EP-A1-1 544 001, to use a rubber member bonded to the surface of the tyre and forming a support for the electronic device. The rubber member is sometimes called a “patch”.

This member produces a mechanical transition between the rigid device and the flexible tyre so that the device does not disrupt the behaviour of the tyre. This is sometimes called mechanical decoupling produced between the electronic device and the tyre.

The particular object of the invention is to propose a member which allows a better endurance of the assembly of the member to the surface of a tyre.

Accordingly, the subject of the invention is a member forming a support for a device, comprising a connecting portion for connecting with a tyre and a supporting portion for supporting a device, the connecting portion comprising a connecting surface for connecting with the tyre, an upper surface and a peripheral edge, wherein the peripheral edge is delimited by a joining surface between the mutually opposite upper surface and connecting surface, converging on their joining surface at an angle α of between 9 and 15 degrees.

Preferably the angle α is between 10 and 12 degrees.

The angle of the borders of the member is an important parameter to be taken into consideration so that the attachment of the member to the tyre is durable. Specifically, if this angle is less than 9 degrees, folds can appear on the border of the member because it is difficult to correctly flatten its peripheral edge. This is called curled edging. If this angle is greater than 15 degrees, the peripheral edge of the member is too rigid so that it creates stresses that are too great on the surface of the tyre and causes cracks or peeling when running.

The joining surface of the peripheral edge may be substantially a joining line.

Alternatively, the joining surface of the peripheral edge may be a surface normal to the connecting surface and have a height of between 0.1 and 0.2 mm.

The peripheral edge may also comprise, in addition, a cord of substantially rectangular section of the same thickness as the joining surface and extending outwards from 0 to 1.5 mm. This connecting surface and this cord notably make venting easier when the member is moulded.

The member may also comprise a layer of connecting rubber placed on the connecting surface without overlapping in line with the peripheral edge of the member.

The member is usually manufactured by moulding followed by curing. A layer of uncured connecting rubber designed to make the connection between the surface of the tyre and the connecting surface of the member is then placed on the connecting surface. The thickness of this layer of connecting rubber is of the order of 0.3 mm. A cut-out is then made of the member and connecting-rubber layer assembly for example with a hollow punch. The cut-out surface of the connecting rubber must be exactly in line with the cut-out surface of the cord of the member.

This makes it possible to avoid, after assembly on the surface of the tyre, having a connecting-rubber layer that protrudes from the member. Such a protrusion may cause a reduction in the service life of the assembly by oxidation of the protruding connecting rubber.

The presence of the cord increases the tolerance margin of the operation to cut out the member comprising the connecting rubber. The risk of biting on the inclined portion of the upper surface becomes practically zero.

A further subject of the invention is a tyre that comprises a member as defined above.

The invention will be better understood on reading the following description given only as an example and made with reference to the appended drawings in which:

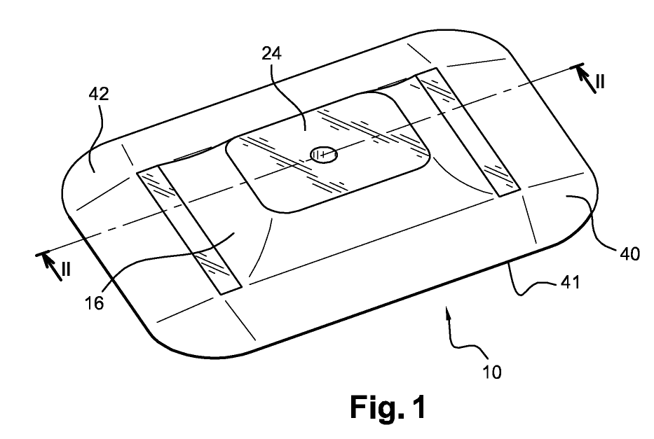

FIG. 1 is a view in perspective of a member according to the invention,

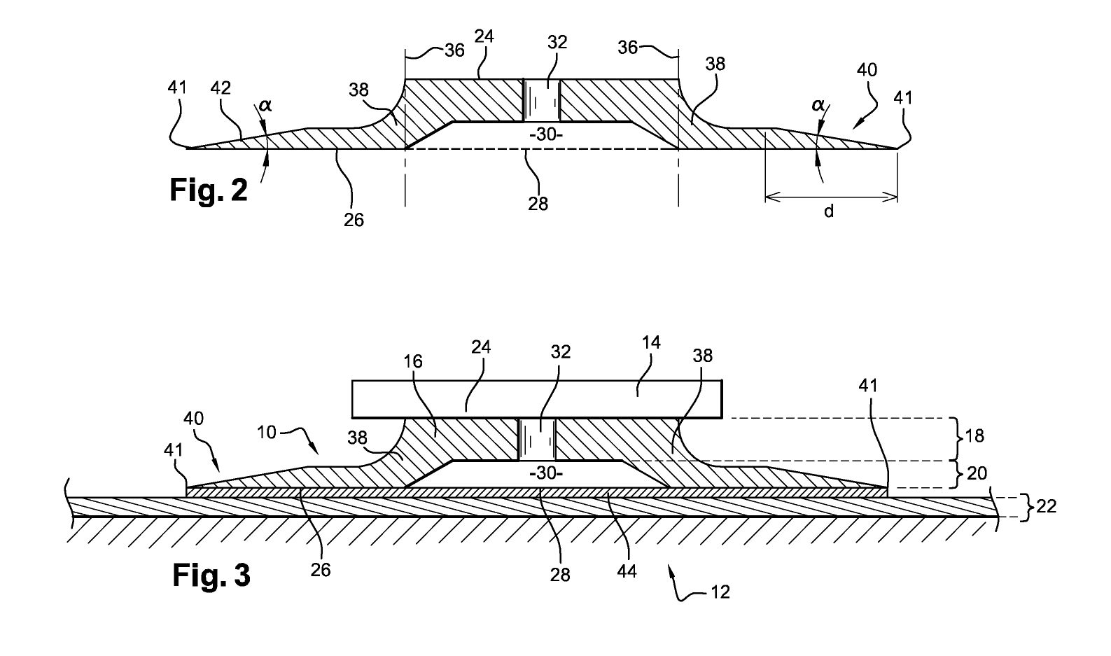

FIG. 2 is a view in section of the member of FIG. 1 on the plane II-II of FIG. 1, and

FIG. 3 is a view in section of the member of FIG. 1 when it is fitted to a tyre and it supports a device.

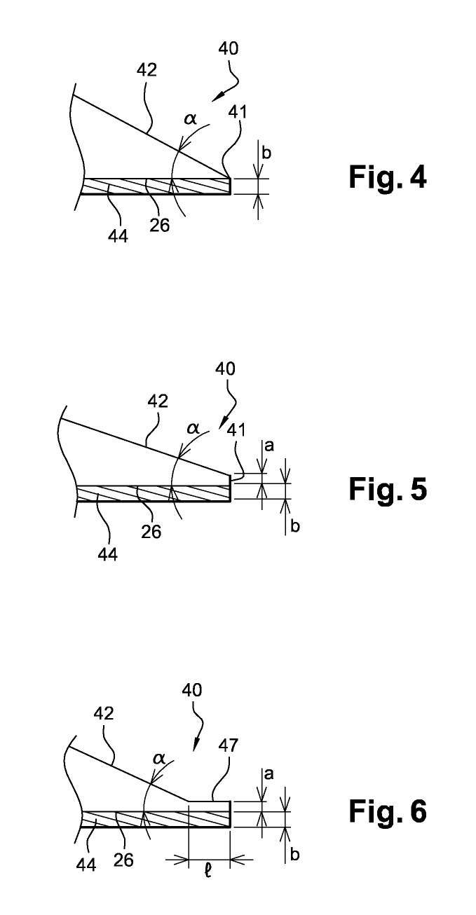

FIGS. 4 to 6 are enlarged views in section of several embodiments of a peripheral edge of a member.

“Modulus of elasticity” of a rubber or rubbery mixture is understood to be a secant modulus of extension at 10% of deformation and at ambient temperature or specified temperature; the measurement is taken after a first cycle of accommodation up to 10% of deformation:

$$- {E}_{10} = \frac{{F}_{10}}{S \times {ɛ}_{10}} i . e . {E}_{10} = \frac{{F}_{10} ( 1 + {ɛ}_{10} )}{{S}_{0} \times {ɛ}_{10}} and {E}_{10} = \frac{{F}_{10} \times 1.1}{{S}_{0} \times 0.1}$$

in which ε₁₀ is equal to 0.1;

where E₁₀: secant modulus of extension at 10% of deformation; F₁₀: force of extension at 10% of extension; S₀: initial section of the test specimen; S, section of the test specimen at the deformation of extension ε, in the case of rubber material, it is known that:

$$S = \frac{{S}_{0}}{1 + ɛ} ;$$

and ε₁₀ deformation of extension at 10%.

The figures show an example of a member according to the invention suitable for a passenger vehicle. The member is designated by the general reference number 10 and is designed to be fitted to a tyre 12 and to form a support for a device 14. This device 14 may be of various types, for example electronic (pressure sensor, temperature sensor, etc.), mechanical or other type.

The member 10 comprises a mass 16 of rubber which, as shown in FIG. 3, comprises a portion 18 for supporting the member 14 and a portion 20 for connecting with the tyre 12. The portions and 20 are made in one piece and their separation is imaginary. The mass 16 of rubber is obtained by moulding.

The member 10 is designed to be fitted on a surface preferably inside the tyre. In FIG. 3, the member 10 is fitted to an internal sealing rubber 22 of the tyre 12. The internal rubber 22 forms a complementary portion for connecting the connecting portion 20 of the member 10.

The mass 16 of rubber is delimited by a surface 24 for supporting the member 14, the surface 24 being constituted by the upper surface of the supporting portion 18. The dimensions of the supporting surface 24 are approximately 15 millimetres×12 millimetres (mm). The device 14 carried by the supporting surface can have dimensions greater than those of the supporting surface 24 as shown in FIG. 3.

The mass 16 of rubber is also delimited by a surface 26 for connecting with the tyre 12, opposite to the supporting surface 24 and substantially parallel to the latter. The connecting surface 26 is constituted by the lower surface of the connecting portion 20 of the member 10. The dimensions of the connecting surface 26 are approximately 40 mm×32 mm.

The two surfaces 24 and 26 are substantially flat and are approximately 4 mm apart from one another.

The member 10 comprises an opening 28 arranged in the connecting surface 26 and delimiting a recess 30 arranged in the mass 16. The opening 28 is represented in dashed line in FIG. 2. The depth of the recess 30 is approximately 1.5 mm.

It will be noted that, because of the presence of the recess 30 in the mass 16, there is at least one imaginary sectional plane of the mass 16 substantially parallel to the opposite surfaces 24 and 26 in which the section of the mass 16 has a generally annular shape.

The mass 16 is formed so that the supporting surface 24 extends at least partially in line with the surface of the opening 28. In other words, the orthogonal projection of the surface 24 onto the connecting surface 26 delimits the surface of the opening 28.

In the example shown in FIG. 2, the orthogonal projection of the supporting surface 24 onto the connecting surface 26, symbolized by projection lines 36, coincides substantially with the opening 28.

Because of the recess 30, the portion of the mass 16 that is situated in line with the connecting surface 24 and which is therefore made rigid by the presence of the device 14, is not in contact with the internal rubber 22 of the tyre 12.

The supporting portion 18 is connected to the connecting portion 20 by bridges of material 38 connected to the periphery of the supporting portion 18. These bridges of material 38 are not very thick, for example 4 mm thick, so they are flexible and they allow a relative movement of the two portions 18 and 20, notably in the case of deformations of the tyre 12 or vibrations of the device 14. This makes it possible to further enhance the mechanical decoupling between the tyre 12 and the device 14.

The mass of rubber optionally also comprises a channel 32 that is arranged in the supporting portion 18 of the mass 16 and that leads on one side to the supporting surface 24 and on the other side to the bottom of the recess 30. This channel makes it possible to correctly position the device 14 on the supporting surface 24. It also makes it easier to stick the member 10 to the tyre while avoiding trapping air in the recess 30. Finally, it allows a fluidic communication between the recess 30 and the air inside the tyre by cooperating with a similar channel arranged in the device. Therefore, variations in pressure or in temperature of the tyre do not cause pressure differences between the inside of the tyre and the inside of the recess which differences are sources of deformations of the member.

The rubber used for producing the connecting portion 20 of the mass 16 is a rubber the modulus of extension of which, at 10%, is at most equal to that of the tyre 12. In other words, the connecting portion 20 is more flexible than the internal rubber 22. As an example, for a modulus of extension at 10% of the internal rubber 22 of the tyre equal to 2.2 MPa at 65° C., to manufacture the member 10, a rubber should be chosen having a modulus of extension at most equal to 2.2 MPa at 65° C. For good endurance of the assembly, the modulus of the rubber of the member should comply with this limit value throughout the whole temperature range of the tyre when running, for example between 0 and 80 degrees Celsius. The rubber used may be natural or synthetic.

The connecting portion 20 of the member 10 comprises a peripheral edge 40 delimited by the joining line 41 between the connecting surface 26 and an upper surface 42 of the connecting portion 20. For manufacturing purposes, and notably to make venting easier during moulding, the joining line 41 can be of a thickness different from zero but can be very thin, of the order of 0.1 to 0.2 mm. In this case, it is then called the joining surface 41. The two surfaces 26 and 42 converge on the joining line 41 and, between them, close to the line 41, form an angle α of between 9 and 15°, preferably between 10 and 12°.

As shown in FIG. 3, the member 10 is secured to the tyre 12 by means of a connecting material 44, inserted between the connecting surface 26 of the member 10 and the internal rubber 22. This connecting layer 44 extends over the whole length of the connecting surface 26 but does not protrude. In other words, the connecting layer 44 is flush with the peripheral edge 41.

Preferably, the angle α between the two surfaces 26 and 42 is between 10 and 12 degrees in a zone of the peripheral edge 40 that extends up to a distance d of approximately 7 mm from the joining line 41.

FIGS. 4 to 6 show in section enlargements of three embodiments of the peripheral edge 40.

In FIG. 4, the two surfaces 26 and 42 join to form a joining line 41, that is to say a joining surface 41 of zero thickness.

In FIG. 5, the peripheral edge 40 is delimited by a joining surface 41 that is normal to the surface 26 and has a thickness a of the order of 0.1 to 0.2 mm.

In FIG. 6, the peripheral edge 40 comprises a cord 47 that has a rectangular section and that extends over a distance 1 of between 0 (as in FIG. 5) and approximately 1.5 mm.

The presence of this cord 47 and of the joining surface 41 make it easier to vent the moulds for manufacturing the members. It is also possible to use vents for example in other locations and maintain a geometry as illustrated in FIG. 4.

FIGS. 4 to 6 also show the layer 44 of connecting rubber placed against the connecting surface 26, with a thickness b of the order of 0.3 mm. This layer of connecting rubber ends at the peripheral edge without going beyond the cord or the surface or the joining line.

Finally, the invention is not limited to the example described above since it is possible, for example, to use all geometries for the supporting portions of the device, no recess in the mass 16 or a plurality of recesses in the mass 16.

1-7. (canceled)

8. Member forming a support for a device, comprising a connecting portion for connecting with a tyre and a supporting portion for supporting a device, the connecting portion including a connecting surface for connecting with the tyre, an upper surface, and a peripheral edge, wherein the peripheral edge is delimited by a joining surface between the upper surface and the connecting surface, which are mutually opposite, converging on the joining surface at an angle of between 9 and 15 degrees.

9. Member according to claim 8, wherein the angle is between 10 and 12 degrees.

10. Member according to claim 8, wherein the joining surface of the peripheral edge is substantially a joining line.

11. Member according to claim 8, wherein the joining surface of the peripheral edge is normal to the connecting surface and has a height of between 0.1 and 0.2 mm.

12. Member according to claim 11, wherein the peripheral edge includes a cord of substantially rectangular section of a same thickness as that of the joining surface and extends outwards from 0 to 1.5 mm.

13. Member according to claim 8, further comprising a layer of connecting rubber placed on the connecting surface without overlapping in line with the peripheral edge.

14. Member according to claim 8, wherein the member is incorporated in a tyre.
